(19) United States
(12) Patent Application Publication
(10) Pub. No.: US 2011/0291962 A1
(43) Pub. Date: Dec. 1, 2011

(54) TOUCH-TYPE TRANSPARENT INPUT DEVICE

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/942,163

(22) Filed: Nov. 9, 2010

(30) Foreign Application Priority Data
Jun. 1, 2010 (CN) 201010188647.3

(51) Int. Cl. G06F 3/041

(52) U.S. Cl. 345/173

(57) ABSTRACT

A touch-type transparent working in input mode or display mode includes a transparent display screen, a touch screen, a central processing unit, a touch screen controller, and a display screen controller. The touch screen is located on the transparent display screen and electronically connected to the transparent display screen. The display screen controller controls the transparent display screen to display user interfaces correspond to the operating modes under the control of the CPU. At least one function key for switching the operating modes is displayed on the transparent display screen. Touch actions are performed on a user interface. The touch screen controller sends touch signals according to touch locations or touch trajectories on the touch screen to the CPU.

### BACKGROUND

1. Technical Field

The present disclosure generally relates to touch-type input devices, and particularly to a touch-type transparent input device for use with an electronic device.

2. Description of Related Art

Keyboards, mice, and handwriting boards are the most common input devices. Generally, the keyboard, the mouse, and the handwriting board are independent devices and designed to implement their respective function. According to different input requirements, the user usually has to replace the input device that is being used.

Therefore, there is room for improvement within the art.

### BRIEF DESCRIPTION OF THE DRAWINGS

Many aspects of the present touch-type transparent input device can be better understood with reference to the following drawings. The components in the drawings are not necessarily to scale, the emphasis instead being placed upon clearly illustrating the touch-type transparent input device. Moreover, in the drawings, like reference numerals designate corresponding parts throughout the several views.

FIG. 1 is an exploded view of a touch-type transparent input device, according to an embodiment.

FIG. 2 is a cross-sectional view of the display screen shown in FIG. 1.

FIG. 3 is a circuit block diagram of the touch-type transparent input device shown in FIG. 1.

FIG. 4 is a schematic view of the touch-type transparent input device shown in FIG. 1 working in mouse mode or handwriting mode.

FIG. 5 is a schematic view of the touch-type transparent input device shown in FIG. 1 working in keyboard mode.

FIG. 6 is a schematic view of the touch-type transparent input device shown in FIG. 1 working in read mode.

### DETAILED DESCRIPTION

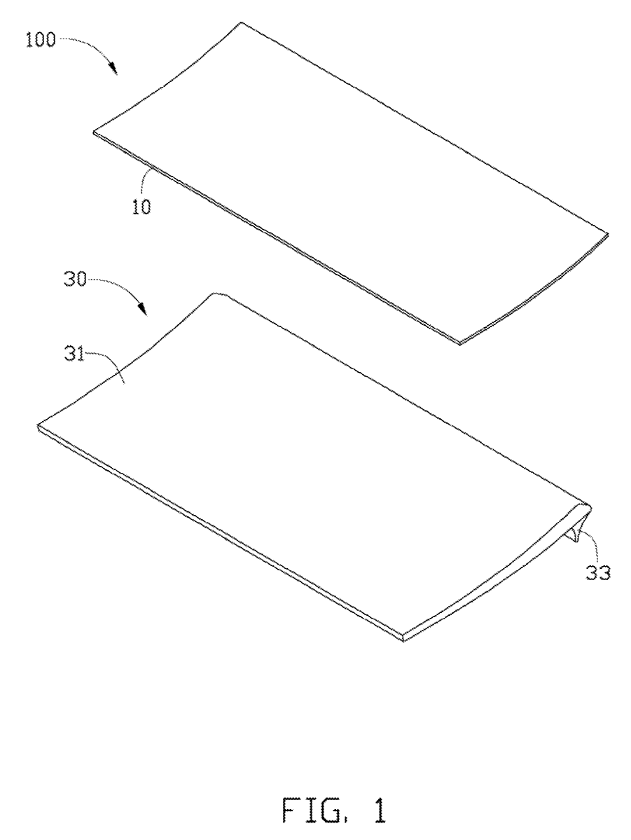

Referring to FIG. 1, an embodiment of a touch-type transparent input device 100 includes a touch screen 10 and a transparent display module 30. The transparent display module 30 includes a transparent display screen 31 electronically connected to the touch screen 10 and a support portion 33. The touch screen 10 is located on the transparent display screen 31. The support portion 33 is located under the transparent display screen 31 to support the transparent display screen 31. The support portion 33 is made of transparent material such as transparent glass or transparent resin. In one embodiment, a cross section of the support portion 33 is substantially triangular with the vertex contacting a support surface.

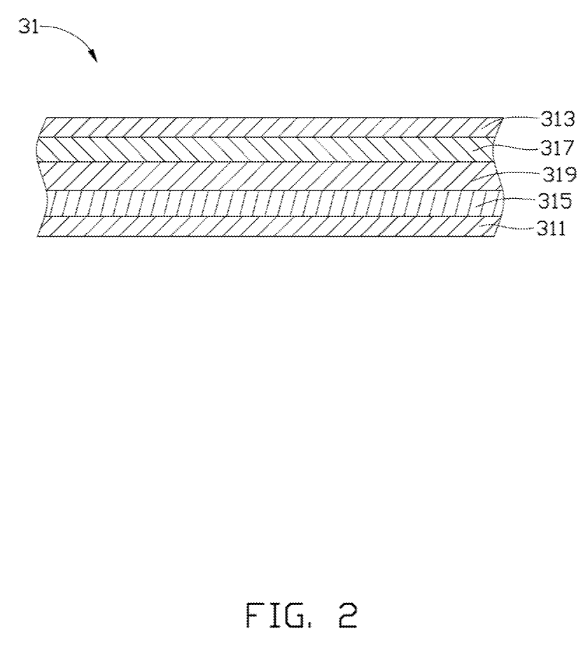

Referring to FIG. 2, the transparent display screen 31 is a transparent organic light emitting diode (TOLED) display screen. From top to bottom, the transparent display screen 31 includes a protective layer 313, a first conductive layer 317, a transparent organic layer 319, a second conductive layer 315, and a substrate 311. The transparent organic layer 319 is located between the first conductive layer 317 and the second conductive layer 315. The protective layer 313 is attached to the first conductive layer 317, and the second conductive layer 315 is attached to the substrate 311. The protective layer 313 and the substrate 311 may be made of transparent glass or transparent resin. The first conductive layer 317 and the second conductive layer 315 may be made of indium tin oxide (ITO). The organic layer 319 may be made of transparent organic materials such as polyaniline or polyfluorene.

When the transparent display screen 31 is powered on, the first conductive layer 317 acts as an anode, and the second conductive layer 315 acts as a cathode. Electrons are injected into the organic layer 319 from the second conductive layer 315, and holes are injected into the organic layer 319 from the first conductive layer 317. Electrostatic forces bring the electrons and the holes towards each other, the electrons and the holes recombine and release energy in the form of photons. Thus, the transparent display screen 31 is illuminated without backlight. The transparent display screen 31 includes a display drive circuit (not shown) for display control. The display drive circuit may be located in the transparent display screen 31. The display principle of the transparent display screen 31 is the same as the well-known display principle of the organic light emitting diode (OLED) display screen.

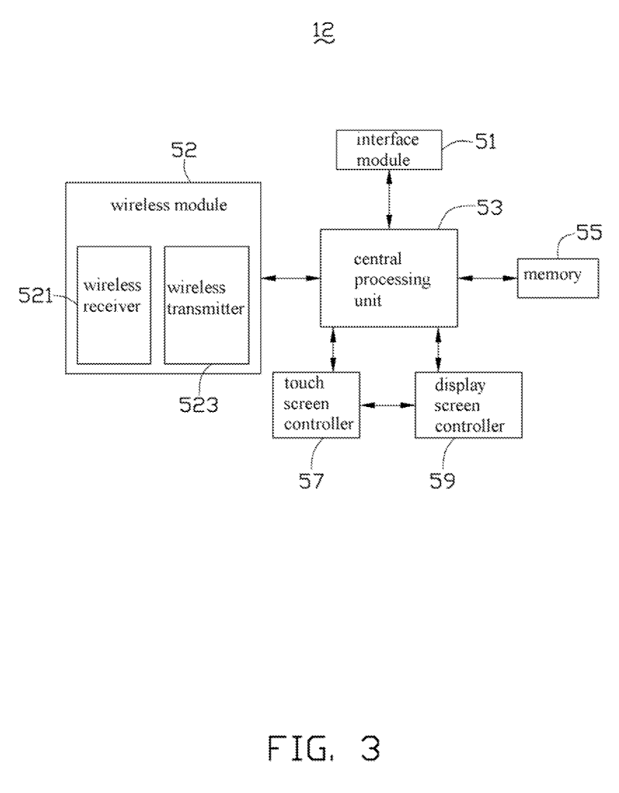

Referring to FIG. 3, the touch-type transparent input device 100 includes a control unit 12. The control unit 12 may be located on a sidewall of the touch-type transparent input device 100. The control unit 12 includes an interface module 51, a wireless module 52, a central processing unit (CPU) 53, a memory 55, a touch screen controller 57, and a display screen controller 59. The touch-type transparent input device 100 may be electronically connected to an external display device such as computers through the interface module 51. The touch-type transparent input device 100 can also communicate with the external display device through the wireless module 52.

The wireless module 52 includes a wireless receiver 521 and a wireless transmitter 523. The wireless receiver 521 may be located on the touch-type transparent input device 100. The touch-type transparent input device 100 and the wireless receiver 521 are detachable. The wireless transmitter 523 is located on the touch-type transparent input device 100. If the touch-type transparent input device 100 needs to communicate with the external display device through the wireless module 52, the wireless receiver 521 is electronically connected to the external display device to receive signals transmitted by the wireless transmitter 523.

The touch screen controller 57 is operable to determine the touch locations when the user touches the touch screen 10, and send touch signals including the touch location information to the CPU 53. According to the touch signals, the CPU 53 sends control signals to an external display device through the interface module 51 or the wireless module 52. The display screen controller 59 enables the transparent display screen 31 to display user interfaces (such as key icons and function menus) under the control of the CPU 53.

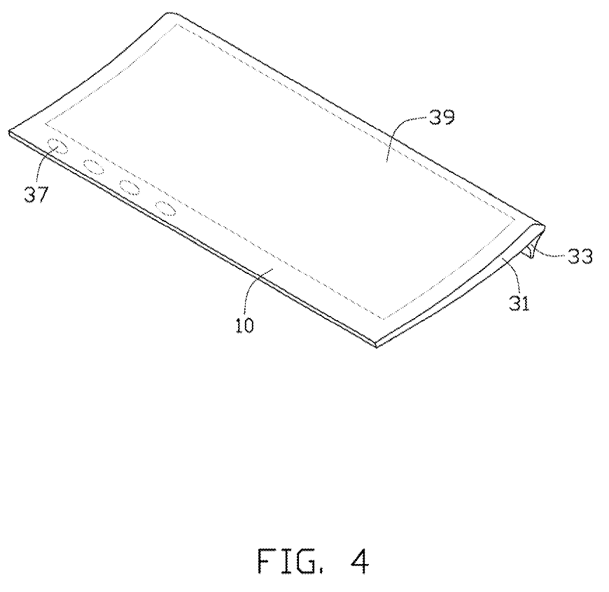

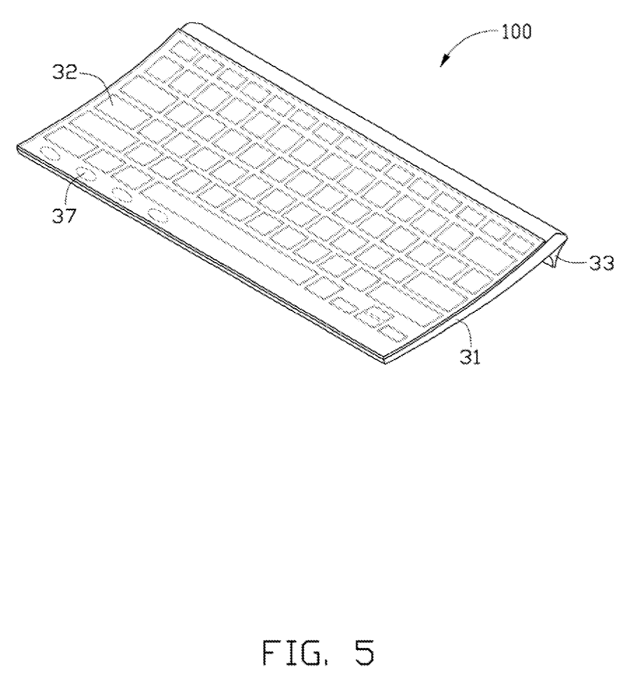

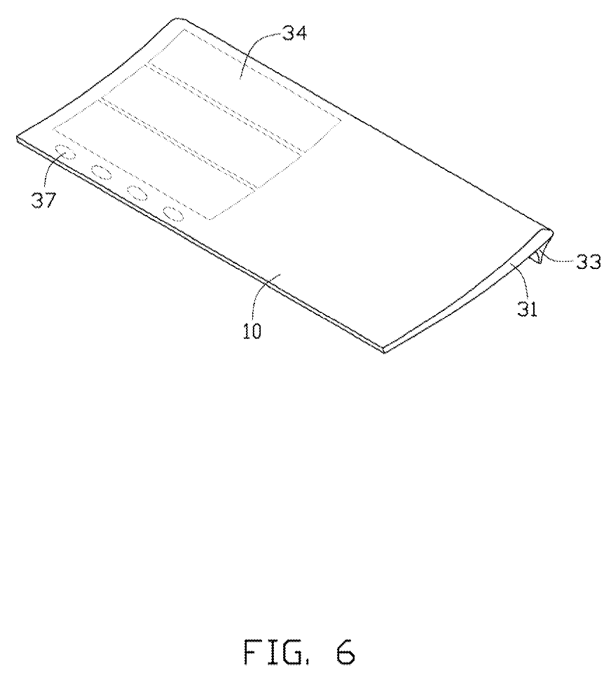

Referring to FIG. 4, FIG. 5, and FIG. 6, the touch-type transparent input device 100 functions as follows:

In one embodiment, the touch-type transparent input device 100 has four operating modes including a mouse mode, a handwriting mode, a keyboard mode, and a read mode. If the touch-type transparent input device 100 is powered on, the transparent display screen 31 displays at least one function key 37 for switching the operating modes. In one embodiment, there are four function keys 37, and each function key 37 is labeled with one operating mode. When a user touches one function key 37, the touch screen controller 57 sends touch signals including the touch location information to the CPU 53. The CPU 53 determines which function key 37 is touched, which operating mode needs to be performed, and sends an interface display signal that corresponds to the operating mode to the display screen controller 59. According to the interface display signal, the display screen controller 59 controls the transparent display screen 31 to display user interfaces corresponding to the operating mode of the function key 37 that has been touched.

The touch-type transparent input device 100 working in mouse mode or handwriting mode is shown in FIG. 4. In mouse mode or handwriting mode, the transparent display screen 31 displays an input area 39 as the user interface. In mouse mode, the touch screen controller 57 sends touch signals to the CPU 53 according to touch actions in the input area 39. According to the touch signals, the CPU 53 sends control signals to an external display device such as computers through the interface module 51 or the wireless module 52. Thus, a cursor on the external display device is moved corresponding to the touch actions. The handwriting mode is similar with the mouse mode except that touch trajectories corresponding to the touch actions are displayed on the external display device.

The touch-type transparent input device 100 working in keyboard mode is shown in FIG. 5. In keyboard mode, the transparent display screen 31 displays a number of key icons 32 as the user interface. Character information of the key icons 32 is stored in the memory 55. The character information of the key icons 32 corresponds to touch locations of the touch screen 10. When a user touches the touch screen 10, the touch screen controller 57 sends touch signals to the CPU 53. The CPU 53 determines which key icon 32 is touched, and sends control signals including the character information of the key icon 32 to the external display device through the interface module 51 or the wireless module 52. The external display device displays the character information of the key icon 32 that has been touched.

The touch-type transparent input device 100 working in read mode is shown in FIG. 6. In read mode, the transparent display screen 31 displays a function menu 34 as the user interface. The user touches the function menu 34 to choose read materials stored in the memory 55. The touch-type transparent input device 100 may download read materials from the external display device through the interface module 51 or the wireless module 52.

The touch-type transparent input device 100 has a variety of operating modes which can be switched through the function key 37.

It is to be understood that the mouse mode, the handwriting mode, and the keyboard mode may be collectively referred to as the “input mode.” The read mode may be referred to as the “display mode.”

In another embodiment, there is only one function key 37, and the operating mode switching can be achieved by continuous touches on the function key 37.

In yet another embodiment, the function key 37 may be a transparent entity key, and the function key 37 is located on the sidewall of the transparent display screen 31.

In other embodiments, the touch screen 10 may be a capacitive touch screen, a resistance-type touch screen, a surface acoustic wave touch screen, or an optical touch screen.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A touch-type transparent input device working in different operating modes, the operating modes comprising an input mode and a display mode, the touch-type transparent input device comprising:
a transparent display screen;
a touch screen located on the transparent display screen and electronically connected to the transparent display screen;
a central processing unit (CPU);
a touch screen controller operable to send touch signals to the CPU; and
a display screen controller operable to control the transparent display screen to display user interfaces corresponding to the operating modes under the control of the CPU;
wherein each operating mode corresponds to a user interface; at least one function key for switching the operating modes is displayed on the transparent display screen; touch actions are performed on a user interface; the touch screen controller sends touch signals according to touch locations or touch trajectories on the touch screen to the CPU.

2. The touch-type transparent input device as claimed in claim 1, wherein the input mode comprises a mouse mode, a handwriting mode, and a keyboard mode; the display mode comprises a read mode.

3. The touch-type transparent input device as claimed in claim 2, further comprising an interface module, wherein the touch-type transparent input device is electronically connected to an external display device through the interface module.

4. The touch-type transparent input device as claimed in claim 2, further comprising a wireless module, wherein the touch-type transparent input device communicates with an external display device through the wireless module.

5. The touch-type transparent input device as claimed in claim 4, wherein the wireless module comprises a wireless receiver and a wireless transmitter; the wireless receiver and the touch-type transparent input device are detachable, and the wireless transmitter is located on the touch-type transparent input device.

6. The touch-type transparent input device as claimed in claim 2, wherein the transparent display screen is a transparent organic light emitting diode display screen.

7. The touch-type transparent input device as claimed in claim 6, wherein the transparent display screen comprises a protective layer, a first conductive layer, a transparent organic layer, a second conductive layer, and a substrate; the transparent organic layer is located between the first conductive layer and the second conductive layer, the protective layer is attached to the first conductive layer, and the second conductive layer is attached to the substrate.

8. The touch-type transparent input device as claimed in claim 2, further comprising a memory electronically connected to the CPU.

9. A touch-type transparent input device working in different operating modes, the operating modes comprising an input mode and a display mode, the touch-type transparent input device comprising:
a transparent display screen;
a touch screen located on the transparent display screen and electronically connected to the transparent display screen;
a central processing unit (CPU);
a touch screen controller operable to send touch signals to the CPU; and
a display screen controller operable to control the transparent display screen to display user interfaces corresponding to the operating modes under the control of the CPU;
wherein each operating mode corresponds to a user interface; at least one function key for switching the operating modes is located on the transparent display screen; touch actions are performed on a user interface; the touch screen controller sends touch signals according to touch locations or touch trajectories on the touch screen to the CPU.

10. The touch-type transparent input device as claimed in claim 9, wherein the input mode comprises a mouse mode, a handwriting mode, and a keyboard mode; the display mode comprises a read mode.

11. The touch-type transparent input device as claimed in claim 10, further comprising an interface module, wherein the touch-type transparent input device is electronically connected to an external display device through the interface module.

12. The touch-type transparent input device as claimed in claim 10, further comprising a wireless module, wherein the touch-type transparent input device communicates with an external display device through the wireless module.

13. The touch-type transparent input device as claimed in claim 12, wherein the wireless module comprises a wireless receiver and a wireless transmitter; the wireless receiver and the touch-type transparent input device are detachable, and the wireless transmitter is located on the touch-type transparent input device.

14. The touch-type transparent input device as claimed in claim 10, wherein the transparent display screen is a transparent organic light emitting diode display screen.

15. The touch-type transparent input device as claimed in claim 14, wherein the transparent display screen comprises a protective layer, a first conductive layer, a transparent organic layer, a second conductive layer, and a substrate; the transparent organic layer is located between the first conductive layer and the second conductive layer, the protective layer is attached to the first conductive layer, and the second conductive layer is attached to the substrate.

16. The touch-type transparent input device as claimed in claim 10, further comprising a memory electronically connected to the CPU.
